(19) United States
(12) Patent Application Publication
(10) Pub. No.: US 2008/0156176 A1
(43) Pub. Date: Jul. 3, 2008

(54) System For Generating Music

(76) Inventor: Jonas Edlund, Johanneshov (SE)

Correspondence Address: HARNESS, DICKEY & PIERCE, P.L.C., P.O. BOX 8910, RESTON, VA, 20195, US

(21) Appl. No.: 11/628,741

(22) PCT Filed: Jun. 10, 2005
(86) PCT No.: PCT/SE05/00879

§ 371 Date: Sep. 18, 2007

(30) Foreign Application Priority Data
Jul. 8, 2004 (SE) 0401804-0

(51) Int. Cl. G10H 1/00

(52) U.S. Cl. 84/609

(57) ABSTRACT

A method and a device for the music generation are disclosed. The method and device, in at least one embodiment, are advantageously used for generating music in response to of an external process by using material from at least two musical themes. Via musical generators for different types of parts, music is generated from material from parts of the respective type of parts of the musical generators from those musical themes, which include parts of the specific type of part of a generator.

### TECHNICAL FIELD

The present invention relates to a method and a device for musical representation of an external process and also generally to a method and a device for automated music generation that can take place in real-time.

### BACKGROUND

A process such as a computer game can be provided with music in real time in such a way that changes in the process generate changes in the music generated. Existing systems such as for instance Microsoft DirectMusic®, Microsoft® system or system Imuse® developed by Lucas Arts for interactive music reacts to discrete events in a game. A musical interpretation of continuous changes such as for instance a successive approach between two parties in a computer game using these systems requires a “simulation” of the continuous change by means of a sequence of discrete events, each of which has to be given its musical counterpart. If several continuous changes shall be materialised simultaneously musically and independently none of these systems will provide good results.

Music systems such as Microsoft DirectMusic® are built on a recombination of predefined musical fragments. While the fragment is reproduced the ability of the system to react to changes in the computer game is limited. To vary the timbre, dynamics or the gestural characteristics independently is difficult or impossible in a system such as Microsoft DirectMusic®. Music systems such as Microsoft DirectMusic® put a heavy burden on a computer game composer who has to define a number of small fragments and furthermore to define how these may be re-combined.

In the U.S. Pat. No. 5,663,517 to Oppenheim there is proposed a system for “Music Morphing”. However, the system as described therein provides an insufficient treatment of rhythm and metrical characteristics as well as of gestural characteristics and coherence of the harmonic structure for many applications.

### SUMMARY

It is an object of the present invention to provide a flexible and manageable method for generating music.

It is a further object to provide a method of generating music that can cope with real-time constraints and which preferably can be executed in response to an input data stream originating from an external process, such as a computer game.

It is a further object of the present invention to provide a method for generating a continuous flow of music derived in an intelligent manner from a number of underlying musical themes.

These objects and others are obtained by the methods as set out in the appended claims. The invention also extends to music generation systems and software for implementing the methods.

Thus, in accordance with the present invention a number of different musical themes are used to generate a musical output in real time while in an intelligent manner striving to maintain the context of the musical themes.

Preferably the context is maintained by tracking and predicting a number of different parameters representing the context of the musical themes and selecting which notes to play in response to such calculated parameters. The algorithm for accomplishing this can hence use general observations about the context characteristics of the input musical themes, and thereby maintain the context of the played music.

Preferably the context is maintained by tracking and analyzing a number of different parameters representing the context of the currently played music and selecting which notes to play in response to such calculated parameters. The parameters will represent both sounding and non-sounding characteristics of the currently played music. In particular the parameters representing non-sounding characteristics are useful in creating a meaningful context at a high abstraction level and thereby lay a foundation for generating a well-sounding output.

Thus, by recognizing that the context of the music played can be maintained by tracking and analyzing a number of parameters representing context characteristics of the music currently played, the music output will have good musical context and sound good to the human ear.

Advantageously, the music can be built top-down, for example beginning with analysing non-sounding characteristics such as a harmonic analysis and a metric analysis and other before choosing (sounding) note(s) to play.

The context parameters are abstract enough to capture similarities in musical context between on the one hand the just recently generated music and on the other hand specific moments in time in the input themes. Material from those specific moments in the input themes is used to extend the generated music. When the music is generated as a representation of an external process, such as a computer game, being defined as a number of dynamic weights, material from themes with heavier dynamic weights is used more often than material from themes with lighter weights. As a result, changes in the dynamic weights are reflected in the generated music as quasi-improvisational transitions between the different themes while the context characteristics of the heavier input themes are maintained.

A continuous musical change implies that a musical expression is successively transformed into another one. In accordance with the present invention a (computer game) composer or a composer for a different process comprising music can define what the music will sound like in the beginning of the change as well as in the end thereof. The present invention will then interpolate a musical transmission between these two expressions when the change in e.g. a game is generated. Timbre, dynamics, gestural characteristics, articulation, dissonance treatment, harmonic sequence, tempo, agogics etc can be changed successively from one expression to the other. The present invention will thus flow between an arbitrary number of musical expressions and generate an everlasting continuous musical flow. Several contemporary and from each other independent continuous or discrete changes in the process set to music can be shaped musically as simultaneous, continuous or discrete changes in several musical dimensions independent from each other.

### BRIEF DESCRIPTION OF THE DRAWINGS

The present invention will now be described in more detail by way of non-limiting examples and with reference to the accompanying drawings wherein:

FIG. 1 schematically illustrates a device for musical morphing;

FIG. 2 schematically illustrates a device for musical morphing in the case where the number (n) of themes (T) is equal to the dynamic weights/state variables (S);

FIG. 3 is a flow chart illustrating steps performed when generating music.

FIG. 4 schematically illustrates two input data parts more specifically two chords and scale sequence parts, CS₁ and CS₂ and a time axis for the chord and scale sequence part generated;

FIG. 5 schematically illustrates two input data parts more specifically two melody parts Mel₁ and Mel₂ and a time axis for the melody part generated;

FIG. 6 schematically illustrates the cyclicity in the theme, which contains CS₁ and Mel₁ above by depicting their time axis;

FIG. 7 schematically illustrates a suffix tree;

FIG. 8 schematically illustrates a suffix tree with values for musical properties or dimensions according to FIG. 6;

FIG. 9 schematically illustrates how a generator uses a list to collect data from a number of input data parts and is able from these data to determine the value of a property in a segment generated; and

FIG. 10 schematically illustrates how generators collect their respective input data parts from the themes of input data to create representations of the parts so as to be able to generate music by using material from the parts.

### WORDLIST

Chord: 1: A number of simultaneously played or sounding notes. 2: Within the part of music theory, which is denoted harmonic analysis the term chord is used to analyse harmonic sequences and is then usually formalised as a pitch-class set.

Articulation ratio: A property of a lift abbreviated ak. If a is the distance between the previous strike and the strike following thereafter and b is the distance from the previous strike to the lift then ak=b/a.

ScaleChord: An interface implemented by each segment in CS. Models a triple of root, chord and scale. The most important methods are Boolean methods for testing membership in the pitch-class set, which constitute the chord and scale, respectively. A sequence of scaleChords defines a harmonic sequence

Cycle signature: For each input data part and for each step of calculation there is assigned a cycle signature. It consists of a set of integers or cycles such that all numbers divide all integers bigger than themselves and the highest integer is a measure of the length of the part. The cycle signature defines when in time of the input data part that shall be looked upon as more or less similar to each other and will thus define the metrical properties of the part. See further equation (1).

Dimension: Each part is defined as a sequence of segments and each segment contains a number of dimensions the values of which define the properties of the part during the extension in time of the segment.

First Beat: A point in time t of an input data part is a first beat if there is initiated a new chord at t or t (mod p)=0 and p is the bar length of the input data part.

History string: A history string is the sequence of actual values for the d dimensions, which exist at tail similarity to the depth d.

Corner, corner theme, corner part: A state is located in a corner if all state variables are at their minima except one. The corner theme is the theme, which has been assigned this unique variable. The parts of the corner theme constitute corner parts. When the state moves into a corner the generated music will usually converge to the corner theme.

Comparison string: See description of partial tail similarity.

Consonance category: In traditional music theory a note can be more or less dissonant or consonant vis-à-vis other notes. Herein consonance category or consonance value is a property of pairs (pitch, scaleChord). The consonance values are dimensions, which depend of values in superior types of parts, for example, the scaleChords in CS, the harmonic sequence. In Mel there is for instance MelOnCC and MelOffCC, which describe the consonance value of the present pitch at the beginning and end of the segment respectively. MelOnCC is the consonance value for the pitch with respect to the scaleChord valid during the segment while MelOffCC is the consonance value of the pitch with respect to the scaleChord of the subsequent segment.

Different sets of values are possible, for instance:

1. Three values: chord note, scale note and non-scale note.

2. Four values: triad note, different chord note, scale note and non-scale note.

These values are arranged with respect to declining consonance value:

1. Chord note, scale note, non-scale note, or

2. triad note, other chord note, scale note, non-scale note.

Part Now: The input parts keep their time in their own part Now variable, sometimes also called pNow.

Source process: The process, which is interpreted into music. The process can for example be a computer game. In case a static multidimensional set of data is interpreted into music, the set of data can be translated to a process by time transposing one dimension.

Process: A multidimensional set of data for instance a partial set of Rⁿ, which changes over time or as an object which can, while keeping its meaning, be translated into such a set.

Register dimensions: Some musical properties can be described by means of so called register dimensions. The absolute pitch of the melody is described by MelAPitch but also by the register dimension MelPitchReg. For an absolute value there is an upper and lower limit, min and max, the highest and lowest note of the melody part. The register value r in a segment having the absolute value a can be calculated as

r=(a−min)/(max−min).

This gives 0≦r≦1.

A typical way of using register values is described as follows:

When a melody generator is to play a first note the values for the highest and lowest note of the generator, max and min, are first calculated and a value, r, for MelPitchReg is formed by means of interpolation over all themes. Then there is taken a value for the absolute pitch aRaw from aRaw=min+r(max−min). Thereafter a value for MelOnCC is calculated and the pitch of the note for the first note played by the generator is then given by dissolving aRaw to the next pitch having at least this consonance value.

Segment: Input data and generated parts are modelled as sequences of segments having different durations. The end time for each segment is equal to the start time of a subsequent segment.

Greatest common divider, gcd: gcd (a, b), where a and b are integers, is the greatest integer that divides a as well as b.

Bar length: Property of a part. A duration that divides the full extent of the theme, usually an element of the cycle signature. Configured by the user.

State variable, state weight: See weight.

Weight: The source process, which is interpreted musically, can be internally represented by a set of dynamic weights, also denoted state variables or state weights. The values of these weights at a given moment represent or code the state of the source process in that moment. The state variables/weights together can be seen as a vector in the state space of the source process. In an implementation in a computer program certain calculations can be simplified if weights are defined by the non-negative real numbers, i.e. they are represented in the computer by floating point numbers greater equal to zero.

The system as described herein advantageously uses the tendency of regular metric structure, which exists in traditional popular music to identify different degrees of similarity between points of time in musical themes. Furthermore the system ensures that the music generated will grow out of itself in a way similar to the way music in an input data grows out of itself in order to maintain the musical context.

In accordance with the present invention music can be generated in real time at one moment at a time. This means for instance that when this system for musical morphing has attacked one or several notes in the same part it is not determined in that moment for how long these notes will sound, but the system will step forward one incremental step in time at a time and make its decision as late as possible in order to be able to consider the changes of state of the source process as well as the musical development.

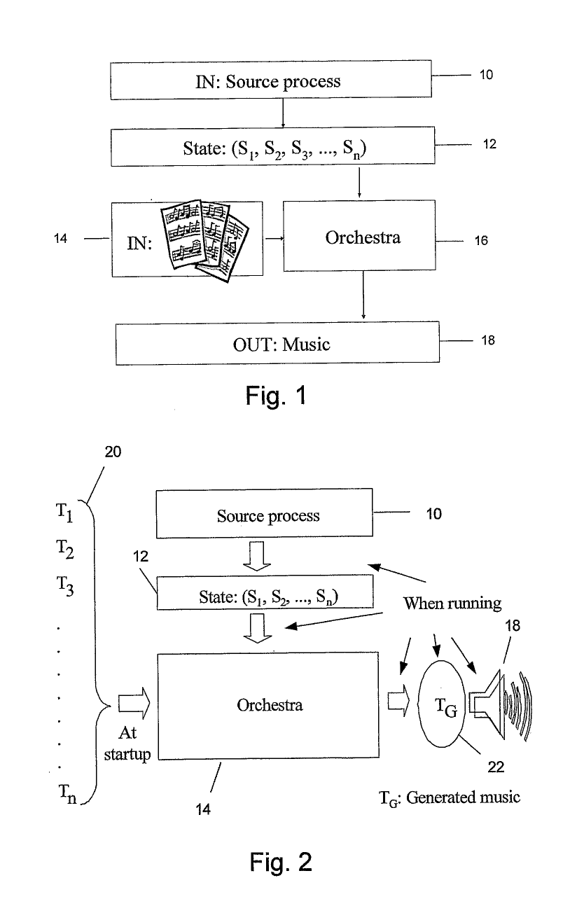

FIG. 1 shows music morphing of a number of themes where the changes are driven by a process and illustrates schematically a device for musical morphing. In the figure there is shown a process 10 which can be a computer game which is interpreted and coded as a set of dynamic weights or variables of state 12 S: {(s₁, s₂, s₃, . . . , sₙ} which in their turn influence the use of material from the available input data 14 by the orchestra 16. The music generated is transferred to a music-generating device 18 via for example MIDI.

Music morphing is music generated by a number of themes each provided with a dynamic state weight. According to one embodiment the state variables/weights are defined over R⁺ [symbol] {0}). It is important to realise that by using a finite number of state variables it is possible to represent an infinite number of states.

When the system as described herein is used to generate music in response to a process the values of the state weights for each moment may constitute an interpretation of the current state of the process. The way in which this representation is created, i.e. how the translation from a source process to state weights is made does not fall within the scope of the present invention although one embodiment of the invention may give support for the execution of the translation.

In a preferred embodiment music material from a theme t with dynamic weight w is used in the generation more the larger the ratio r=w/W where W is to the sum of the dynamic weights of all themes. Any probability function p (r) can be used to express the probable use of material from t as long as p(0)=0, p(1)=1 and the rest of the function is increasing in the interval [0, 1].

The methods and processes as described herein can be embodied in a computer system and can be implemented as computer software. The system can create music from any set of pairs (theme, dynamic weight) regardless of the themes and regardless of changes of the dynamic weights. Below two different applications will be given as examples:
A software program which is run for instance on a conventional personal computer. The user can make a choice between a number of predefined or made up themes and will generate a source process when running by manipulating a graphical user interface.
Computer game manufacturers can use the present invention to create adaptive musical soundtracks for their computer games. The companies can be offered a production environment for composers of computer games, which resemble those used when a film is provided with music. In the environment the translation between the game and state variables and the assignment of variables/weights of themes are handled. It is possible to test run the game with different kinds of music, setting of levels etc.

The system can be integrated for computer games at least at three different levels:
1. Located on a hardware platform such as X-box, gameCube or similar.
2. Integrated into a “game motor” (“3D-motor”, “physics motor”, i.e. the means which offer support for the model in which the game is performed). This facilitates the translation between source process and state variables.
3. Integrated into a single computer game.

FIG. 2 illustrates schematically a device for musical morphing. It illustrates musical morphing in the case when there are as many input themes as state variables and where each theme is assigned a unique state variable. In its general form it is not necessary for the invention to have an equal number of dynamic weights as themes, several themes can share the same s. The device has an input data process 10, dynamical weights 12 S: {S₁, S₂, S₃, . . . , Sₙ}, an orchestra 14 with music generators for different parts and a music playing device 18 in accordance with what has been shown in FIG. 1. Furthermore the device is provided with a set of musical input themes 20 T: {T₁, T₂, T₃, . . . , Tₙ}.

The present invention further has an interface 22 for transition of the music generated by the music generators to a music-playing device 18. The interface 22 can according to one embodiment be a data file for storing the generated music in some format such as MIDI 18.

### Input Data:

### 1. Input Data at the Start (Start-Up):

a. A number of musical themes T: {t₁, t₂, . . . , tₙ}.
   The themes will contain musical information constituted by notes or similar information (MIDI or other format) and information as to the interpretation of these notes herein denoted configuration information.
b. A set of dynamic weights, S: {s₁, s₂, . . . , sₘ}.
c. A mapping T→S so that each t is assigned one and only one s.

### 2. During the Execution of the Present Invention

a. Access to S. The system reads the values of S a number of times per second.

### Output Data:

As output data the system generates the flow of musical information in MDI or other format. This output can be fed to a synthesizer and can be transformed to sounding music. The synthesizer can be arranged on the same computer as the music generating system or output data can be fed to a MIDI output of the computer to enable the music to be played on an external synthesizer. The information can also be written down on a file for further processing or storage.

Each theme of the input data will contain information on no or several parts. This may be information concerning note content (the pitch of the notes played or their start or end in time etc.), timbre (how the notes played shall sound, what instrument that is performing the part) and dynamics (tone intensity/changes in tone intensity). Themes may also contain information as to tempi and changes of tempi.

The music-generating components of the system as described herein can be denoted generators. If the system is viewed as an orchestra 14, the generators would be the musicians of the orchestra. Each part of input is associated with a generator. Each generator will take at most one part from each theme.

Generators and parts exist as a number of different types so that a specific type of generator only handles parts of a certain type and inversely parts of a certain type are intended to be handed by generators of a certain type. A theme may contain several parts of the same type.

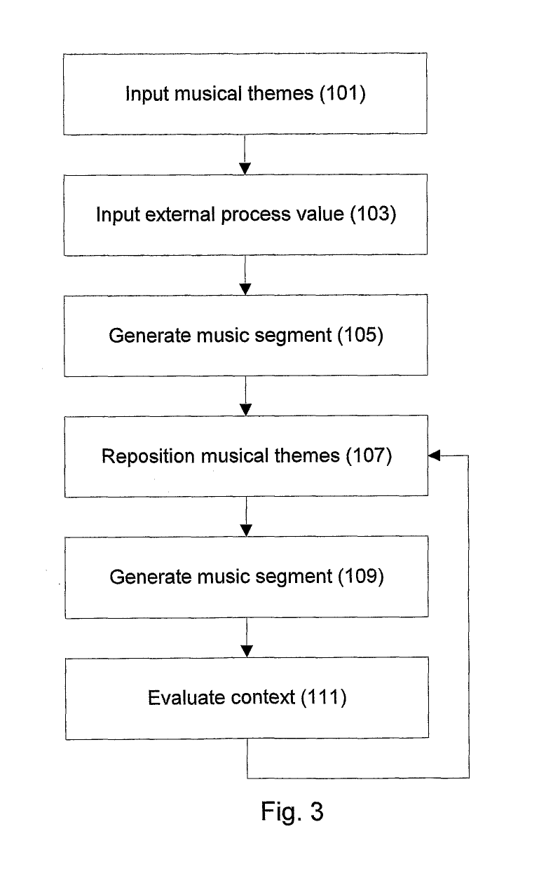

FIG. 3 is a flow chart illustrating different basic steps performed when generating music. In a first step 101 a number of musical themes are read into a memory. Next a value corresponding to an external process is read, step 103. For example, the external process can be represented as a number of dynamic weights each corresponding to different musical themes as described herein.

Thereupon a first musical segment is generated by selecting a first scaleChord representing the harmonic context for the duration of the first segment, step 105. The musical themes are then repositioned if needed, step 107. Next, another segment is generated, step 109. The next segment can be a subordinate contemporaneous segment or a segment later in time in relation to the prior generated segment. When determining the segment in step 109, the system makes use of previously determined context parameters as well as the current weights representing the external process as described herein. Next, context parameters in the new segment are evaluated if needed, step 111. The steps 107 to 111 are then repeated for as long as there is a need to generate a music output.

One aspect of the system as described herein can be viewed as a markov process. A markov process normally means a discrete process (=a process having a finite number of distinct states), where each state is a function of one or several previous states. Such processes can easily be simulated in computers using suffix trees. When constructing these trees the states of the process will be looked upon in such a way that they follow each other as strings over the alphabet, which is constituted by the total state space of the process.

The trees can then easily provide answers of questions of the type “given that the latest k states of the process have been S={sₙ, sₙ₋₁, sₙ₋₂, . . . , sₙ₋ₖ₋₁}, which states sₙ₊1 can be expected after that?”. Furthermore it is possible, if the frequency is supervised considering the frequency of which different states will follow upon different S, to give the probability for different states for different S.

Music is well suited to be considered as markov processes as music can be looked upon as strings of symbols. There are many examples of the use of suffix trees for identifying different styles of music or for generating new music of a certain style.

One of the objects of the system as described herein is to make music grow out of itself in the same way as music within the input data grows-out of itself. To find the right material in input data parts the generators use the following principle, which is herein denoted partial tail similarity of multidimensional strings. The principle can be viewed as a form of markov chains.

Definition of Tail Similarity:

For two strings of symbols g=g₁, g₂, . . . , gⱼ and t=t₁, t₂, . . . , tₖ is valid that g is tail similar to t at position p to a depth d if:

gⱼ=tₚ,
gⱼ₋₁=tₚ₋₁,
. . . ,
g_{j-d+1}=t_{p-d+1}.

### Ex. 1.

If g= . . . abc and t=defg, g does not show tail similarity t at any position.

### Ex. 2.

If g=abc and t=defcg, g shows tail similarity t at position 4 to a depth 1.

### Ex. 3.

If g= . . . aabc and t=defabcghi, g shows tail similarity t at position 6 to a depth 3.

### Ex. 4.

If g= . . . abc and t=debcfgabcd, g shows tail similarity t at position 4 to a depth 2 and at position 9 to a depth 3.

The strings g in the example above are denoted generated strings or g-strings and the strings t are denoted theme strings or t-strings. In the relation tail similarity a generated string according to the present invention is tested for tail similarity vis-à-vis a predetermined theme string.

If the t-string is considered cyclical, i.e. the first symbol also appears after the last symbol the depth can be bigger than the position:

### Ex. 5.

If g=abc and t=cdefab g shows tail similarity t at position 1 to a depth 3.

The discussion is now extended to several dimensions.

A string of symbols u in n dimensions of a length m is an organised sequence of n-tuples and is denoted

u=(u_{1,1}, u_{1,2}, . . . , u_{1,n}) (u_{2,1}, u_{2,2}, . . . , u_{2,n}), . . . , (u_{m,1}, u_{m,2}, . . . , u_{m,n})
u_{i,j} does thus denote the j:th element of the i:th tuple.

A multidimensional string g can be compared with another string t of the same dimensionality with respect to partial tail similarity by using a comparison string. The comparison string stipulates how the g-string shall be compared with the t-string. The comparison string can be defined in different ways. Here an organised sequence of tuples of integers is used as an example. No tuples has more elements than the dimension of the compared strings. Empty tuples may appear. Let c=(2,1,4), (4), (3) be a comparison string for determining tail similarity between a t-string t and a g-string g with a last tuple with index j. The depth of the tail similarity of g to t at index p is determined by how many of the following sequence of equalities that hold:
1. g_{j,2}=t_{p,2}
2. g_{j,1}=t_{p,1}
3. g_{j,4}=t_{p,4}
4. g_{j-1,4}=t_{p-1,4}
5. g_{j-2,3}=t_{p-2,3}

If all these five equalities are true the depth for the tail similarity at position p is equal to five. If condition 1 is not valid no tail similarity is valid at position p irrespectively of the fact that any of the proceeding conditions may be valid. An empty tuple at one position in the comparison string means that no elements are compared in the corresponding tuple.

By modelling the parts of the music as multidimensional strings where each tuple represents the properties of the music during a segment of time it can be described what aspect of the music and in what segment that has an impact of the properties in the same or subsequent segments of the music does have. These segments thus have a certain duration and the end time of each segment is identical to the start time of the subsequent segment. This way of modelling can be used to analyse input data. The system can then by raising requirements for different types of partial tail similarity between generated music and input data by means of different comparison strings, ensure that the generated music grows out of itself in such a way that it resembles the way in which music of input data grows out of itself even when the generated music is morphing between different themes. The tuples in the previous discussion concerning tail similarity preferably correspond to the segments with which the parts are modelled and the elements in the tuples above do correspond to the values, which describe the properties of the music in one segment. The types of these values can be denoted dimensions.

Complete tail similarity requires that all tuples of the comparison string contain the same number of integers as the number of dimensions of the g and t strings. The completeness does thus consist in the fact that no dimensions are left at the comparison and has nothing to do with the size of the depth.

Another aspect of the system as described herein is the use the tendency of music to use metric regularity. The musical time in traditional music is often experienced as regular, i.e. different moments of the music are experienced to some extent as similar whereby the invention operates according to the principal that “what was played at a certain point of time is also possible to play at similar point of time”.

Thus, it is preferred to use themes which are cyclical and metrically regular with respect to time as input data, i.e. they can be described as consisting of time periods which are multiples of shorter periods. Thus for instance the metric in a 32-bar chorus from an evergreen in ¾-bar can be described as cycles in cycles according to the pattern (4, 8, 3), which means that a chorus is divided in four periods each containing 8¾-bars each. Each part in such a theme may, according to the present invention, be attached to a cycle signature, for example described as {n, n/4, n/(4*8), n/(4*8*3)}. The cycle signature will thus in this example contain four elements, the full length of the chorus (n), the 8-bar period, the ¾-bar and the quarter note.

A cycle signature can be described as a non-empty set of numbers such that all numbers of the set can divide all numbers bigger than itself and the highest number is a measure of the length of the theme. If eights and sixteenths dominate the part, it is possible to extend the cycle signature above to {n, n/4, n/(4*8), n/(4*8*3), n/(4*8*3*2), n/(4*8*3*2*″)}.

This principle for similarity in time can be formulated as follows:
Within one part two points of time t₁ and t₂ are considered to be similar if:

t₁(mod m)=t₂(mod m) equation (1)
where m is an element of the cycle signature of the part and more similar the bigger them is.

It should be noted that musical time usually is expressed in integers, i.e. the correspondence to the time values of the common musical notation (whole notes, half notes, quarter notes etc.), which in ordinary sequencer programs are measured in “ticks” or “clicks”. How fast this musical time moves through “real time”, expressed in seconds is a matter of tempo.

The system obtains one or several cycle signatures. Different signatures can be used for the calculation of different properties in the music generated. Cycle signatures are given in the configuration information of the respective theme.

The computer program executing code for implementing the system can be written in any high level language. The program then contains around one hundred classes most of which represent different musical properties or dimensions. To provide an understanding of the structure of the program a short description of the most important classes forming the infrastructure of the program will now follow.

### ThemeManager

Singleton

Reads themes from a file.

### Producer

Singleton

Is responsible for the generation of musical content. Handles the “musicians”, i.e. the generators.

### Generator

The system comprises generators of a number of different kinds. A generator takes information from parts in one of several themes and builds representation of its parts and generates music as ordered by Producer via a method denoted generateUntil (pointOfTime t). The generators generate musical material concerning the onset and release of notes, the strength of different timbres with respect to one another, volume, tempo etc. The generators may also control processing of the acoustic signal generated for instance by a synthesizer by means of reverb, compression etc. via its messages to Sequencer. Each generator writes the material generated to Sequencer.

### Sequencer

### Singleton

This unit receives musical information from the generators and plays it on a synthesizer API in accordance with its time stamps and/or saves it in a file. The time stamps are expressed in musical time, which means that Sequencer also considers tempo.

Each part is modelled as a continuous sequence of segments/points. Each segment has a duration and each subsequent segment starts when the previous one ends. Each segment has a number of properties or dimensions. The types of these properties/dimensions are different for different types of parts. The sequence of segments constituted by the parts can be considered as walks in multidimensional rooms. Each type of part defines a room with a set of dimensions and each segment in one part has values for all dimensions.

Some of the dimensions according to one embodiment are common to all parts for instance:
1. Ost “onset time” of the segment
2. Off: the end time of the segment
3. Dur: The duration of the segment i.e. the extension in time

Sounding parts are modelled as a sequence in time of strikes and lifts. At a strike none or several notes are attacked at the segments Ost. At a lift zero or several notes are released. According to one embodiment all sounding parts have:
1. Strike: Whether or not the segment is a strike.
2. Last strike: Ost for the latest strike. If this segment is Strike this value is equal to Ost.
3. RemStrikeDur: Remaining strike duration. Time remaining until the next strike.
4. LiftList: A list of all lifts between the latest strike and the following strike containing information concerning the articulation ratio and tone content of each lift.
5. LiftCount: The number of lifts made since the last strike until the end of this segment.

Other properties are special for the type of the part. As an example 5 types of parts can be used:
1. CS: Chord and scale sequence. CS is a mute part, which provides a harmonic sequence for the remaining parts. In CS there is in each segment
   a. The applicable scaleChord.
   b. The root of the scaleChord as a pitch.
   c. The distance between the root of the segment and that of the previous one.
2. Mel: Melody. The melody is a sounding part, which only plays strikes one note at a time. In the melody there exists in each segment among other things:
   a. MelAPitch, the pitch for the last onset note,
   b. MelRelPitch, relative pitch of the last onset note expressed as semi-tone distance from the note before,
   c. MelPitchReg, pitch expressed as location in the register between the highest and lowest note of the melody,
   d. MelDir, the direction of relative pitch that is a sign for MelRelPitch (+, − or 0)
   e. MelOnCC, the consonance value* of the pitch at the beginning of the segment
   f. MelOffCC, the consonance value* of the pitch at the end of the segment
   g. MelVel, dynamics/velocity for the last onset note.
   h. MelRelVel, change of dynamics/velocity compared to the latest onset note.
3. CP, ChordPlayer, a sounding part. The model is at large the same as of the melody but extended to several simultaneously sounding notes. CP accounts for
   a. The distance between simultaneously executed notes on a keyboard.
   b. Definition of location of different scale-functions (roots, thirds, fifths, sevenths etc).
   c. How notes in played chords relate to notes played in previous chords. Velocity, how notes are struck
4. Bass This is also an extension of Mel. The model of the bass part is built on the principle that the bass is played by moving from one chord note to the next chord note, possibly with other notes in between. The bass part contains for each segment among other things dimensions handling
   a. tpne, point of time for next one
   b. tpa, point of time for chord note onset close to next one (anne)
   c. tka, pitch for anne
   d. aa, number of chord notes to be onset after Ost and before tpa.
   e. tpna, point of time for next chord note
   f. tkna, pitch class for next chord note
   g. as, number of scale notes to be played after Ost before tpna
   h. tpns, point of time for next scale note
   i. tkns, pitch for next scale note
   j. ai, number of non-scale notes to be played after Ost before tpns
   k. tpni, point of time for next non-scale note
   l. tni, pitch-class for the next non-scale note
   m. present pitch
   n. Root consonance, an extension of the consonance definition so that prime (root) is more consonant than third and fifth, fifth more consonant than seventh etc.
5. Perc. Percussion part. Basic in the model here is an expression as density expressed as the number of strikes per unit of time.

Certain types of parts are superior to other so as to make values of a superior type affect values of a subordinate type. Thus CS is superior to Mel since MelOnCC and MelOffCC are not dependent of pitch only but also of chords and scale which they are given in segments in CS. As a consequence, for contemporaneous segments, segments in CS have to be generated before the segments in Mel. Generally superior parts are preferably generated before subordinate ones for the same time period.

All relations between parts in superior and subordinate types of parts form a tree where all children are subordinate to their parents. The type of part of the root is not subordinated to any other type of part. This type of part is denoted primary. According to the present embodiment of the present invention CS is the primary type. There is one and only one part of a primary type in each theme called primary part and one and only one generator of primary type in the orchestra.

Each part has its own now denoted pNow (p for part). The primary type plays an important role as all parts, including the primary part are continuously adapting or repositioning their respective pNow based on an inspection of the last generated part of the primary part. When the generator of the primary part is incrementing gNow (g for generator), the input data parts of the generator are simultaneously incremented equally. Thereafter a repositioning of the input data parts pNow takes place. The repositioning in accordance with one embodiment can be described as follows:
1. The orchestra as a whole, all generators and all their input data parts counts time from zero when the orchestra starts to play.
2. When the generator of the primary part has finished the generation of one segment it increments its gNow by the duration of the segment d=kₘ−t where t is the starting time of the segment and kₘ is the smallest element of the K-set of the generator (see below) which is bigger than t. Thereafter the generator calculates for each of its input parts a unique value, iNow: =pNow+d, for each part.
3. Each part will then determine, if possible, one or several values of its now denoted hNow (h for history) by searching for tail similarity between the newly generated primary part and the primary part of its own theme. CS is a primary part in one embodiment of the implementation of the present invention and tail similarity is decided for the scale chord valid and relative and absolute keynote. According to the present invention each input data part can thus orient itself in the harmonic sequence generated either with respect to both its absolute pitch and its transposed pitch. Repositioning related to the contents of the harmonic sequence is complemented with repositioning after harmonic pulsation, i.e. the points of time at which the generated harmonic sequence changes scaleChord.
4. If an inspection/comparison only gives one possible value for hNow, the pNow=hNow for the part if there is an m of the relevant cycle signature such that:

iNow(mod m)=hNow(mod m) equation (2)
If there are several possible values for hNow, M={hNow₁, hNow₂, . . . } then pNow:=hNowᵢ is set
for an hNowᵢ in M which meets the equation (2) with the highest value for m, i.e. an hNow which is most similar to iNow. If the inspection/comparison does not give any possible values for hNow or it does not exist any m in the valid cycle signature, which meets equation (2) pNow: iNow (mod n) is set, where n is the length of the theme.
5. The remaining input data parts obtain their correct position in time via their own Cs.

According to one embodiment the input data parts use a further value to find similarity according to equation (2), i.e. the greatest common divider of the shortest cycles in their own valid cycle signature secondly the cycle signature valid for the heaviest CS input data part. This ensures good control of changing bar-modes.

In accordance with one embodiment a variable that can be termed “positionMaster” (PM) is used in the CS generator. PM is initiated to the heaviest input data part in CS. When repositioning an input data part S, a new position can also be chosen in accordance with equation (2) where m=gcd (S.sc, PM.sc) and sc denotes the “shortest cycle”. It is thus possible to find the greatest common divider for the shortest cycle in a cycle signature for the part which is to be repositioned and the shortest cycle in a cycle signature for positionMaster and use that value for m in equation (2) if similarity can not be met with higher values for m. This is herein denoted reposition with respect to positionMaster.

When the CS-generator according to this embodiment repositions its input data parts that is made with respect to the former positionMaster and there after the heaviest part will become a new positionMaster.

Together with another definition, barGroup, good control of changing metrics is achieved. Two input data parts A and B belong to the same barGroup if A.sc divides B.sc or B.sc divides A.sc where sc refers to their shortest cycle as above. When the CS-generator is to determine the time for a new scale chord only such input parts, if the system is thus configured by the user, may take part in the decision which belong to the same barGroup as the heaviest input data part. A similar mechanism can be used for deciding strike onset times in sounding parts.

According to a further embodiment changing metrics are controlled by letting input data bars from different barGroups, having a weight above a determinable threshold value, take turns of having the corresponding privilege.

The time of the input data parts as represented by their pNow is cyclical. The time of the generators however is linear. It is continuously increasing.

Through the combination of cycle signatures and repositioning the user of the system is given good control of the metrics of the music generated.

In order to make the primary type maintain its role as time referent it is necessary that it should be defined for all points in time in all themes and for all points in time in the generated music where any sounding generator is active. The generator of the primary type cannot take any pause as long as any sounding generator does not. As mentioned above CS is a primary type according to one embodiment. Alternatively the melody can for instance be its own primary type if it plays a pure solo. Repositioning would then suitably be made by determining of tail similarity over relative pitches and durations.

The algorithms controlling the different generators have many properties in common but some properties are special. Each generator generates a sequence of segments, a walk in the space, which belongs to the type of the generator. All dimensions in one segment have to be determined before the generator proceeds to the next segment. Some dimensions are trivially updated based on values in other dimensions. MelAPitch for instance gives values for MelRelPitch, which in turn gives the value for MelDir. MelAPitch gives together with the values for the highest and lowest notes the value for MelPitchReg.

For each calculation made to determine the value for a dimension in one segment generated without such a trivial updating there is a comparison string, a cycle signature and a minimal depth. The comparison string stipulates what dimensions in what segments and in what order they shall be compared. The generator at such decisions contributes to the values from one input data part if:
1. The theme of the part has a weight bigger than zero.
2. It is possible to find a tail similarity of at least minimal depth between the newly generated part and the input data part at the position given by the pNow of the part according to the comparison string belonging to the relevant decision.

If a sufficient tail similarity does not exist at the pNow of the part, similarity could be sought at a similar point of time in accordance with the valid cycle signature and equation (1).

This way of working involving partial tail similarity is similar to that of using markov chains. If the total musical present is looked upon, all parts simultaneously as defining the state of the music at a certain moment, the number of different states will be unwieldy great. The system breaks down this complexity partly by forming a hierarchy so as to make superior parts to be generated before subordinate ones. So called “rollbacks” can be eliminated by making subordinate parts to adapt them selves to the superior ones. The complexity is also limited by generalisation of musical phenomenon by modelling gestural and metrical characteristics and dissonance treatment.

New generated values for the different dimensions are calculated either trough choice or through interpolation. Choice implies that the generator chooses one of the alternatives, which is offered by the input data parts which can show sufficient tail similarity. The alternative is either the one having the highest dynamic weight or is achieved by an arbitrary choice between different alternatives taken into consideration the dynamic weights of the alternatives so as to give heavier alternatives a higher chance to be chosen.

In interpolation the values of one or several parts are weight together. Consideration is taken to the dynamic weight of the parts but also the frequency with which a certain value appears at the given history string. Several different values can exist at same comparison string and depth since several points of time can be almost similar to another according to equation (1).

The details of this search for relevant values can be accomplished in several ways. The search can be said to be achieved over three directions: over different themes, over different requirements of depth concerning tail similarity and over different similarity between different points of time according to equation (1). Different strategies can be used for different decisions. For example, search for a maximal requirement of depth should imply that the whole generated part should show complete tail similarity for all dimensions to the complete depth corresponding to the whole length of the part in order to make material from the part usable.

According to one embodiment search over the biggest cycle for a certain depth d implies that tail similarity is required to the depth d for the actual point of time pNow (mod n) where n is the measure of the complete length of the part and not for shorter cycles.

If the input data parts are different a demand for both maximal depth and highest cycle could in the end be met with by at most one input data part this would make morphing impossible at that time.

The strictness for both these demands can be lowered at different orders. Search can be made with a demand for big depth but at ever more less similar points of time (short cycles) or with ever more less demands for depth but primarily at more equal points of time (long cycles).

It will also be possible to detect different strategies in the search in the sense that material could be found from one or a limited number of parts or that it is aimed to find material from as many parts as possible. A first strategy implies a search over all parts simultaneously and that the requirements are successively lowered with respect to depth and time similarity until at least one hit have been obtained. This strategy can be denoted “first come, first served”. A second strategy implies that there is a search over one part at a time and that the requirements are successively lowered to a minimum, which are the lowest depth and a shortest cycle in order to give all the parts the possibility to contribute with material. This strategy is here denoted “egalitarian”. Intuitively the first-come-first-served strategy is better matched to choices. The egalitarian strategy is likely better suited for interpolation since it uses values for all parts, which show sufficient tail similarity.

If a search with minimum demands do not result in any hits this means that no input data parts recognise themselves sufficiently in the recently generated material. There can be several reasons for this. Independently of the reason there is need of another approach. A set of rules can be used to resolve such a situation. All generators must deliver data under all circumstances irrespectively of input data and independently of the changes of state of the target process.

It is further desired to avoid performing unnecessary calculations. Especially, the now-variables of the generators and parts benefit from being incremented as efficiently as possible without passing by any of the “critical moments” where any input part would like to perform a strike. The below description address this:

With respect to strikes, i.e. new chords in CS and onset notes in sounding parts, the following will happen in the constructor of the relevant generator: First there is formed a set S of all elements in all cycle signatures of all parts in the generator. Then there is decided the greatest common divider d of all elements in S. This value d is called the step cycle of the generator. Thereafter there is formed the set A of all points of time in all parts of the generator where there is a strike (all parts starts with zero). By using a first formula (equation 3) there is then formed the set B of all b, which can be formed according to

b=a(mod d) equation (3)

of all a in A. By using a second formula (equation 4) there is then formed the set K of all critical points time k in accordance with

k=b+n*d, bεB, nεN equation (4)

where ε denotes “belongs to the set” and N denotes the natural numbers. The step cycle is d, the elements in B are the “steps” on which the generator steps around in the step cycle, round by round.

The set K of all k which can be formed according to equation (4) is denoted the K-set of the generator of all critical moments or starting points. The generator will never form a complete list of the K-set−K is infinite. On the contrary the set B is an arranged increasingly in a list L′ and thereafter there is created a list L from the difference between each element in L′ and the subsequent one. The generator is now given its variable gNow and the input data parts their pNow, which all are initiated to zero and gNow will then obtain all critical moments k by traversing L over and over and adding its value to gNow. Simultaneously all pNow are increased as much and since repositioning of the input data part pNow now only tales place according to equation (2) no new critical moments will be bypassed. For each new value for gNow the generator creates a new segment

A generator which has a superior generator, i.e. a generator that generates a part of a type which has a superior type, has to consider by development of its step cycle that it also divides the step cycle of the superior generator and that all elements in the B-set of the superior generator are added to its own B-set. This is because the parts of a generator must have segment boundaries where the superior generator has such segment boundaries since a segment boundary in a superior part may imply changes of properties in the subordinate part independently of other changes in the subordinate part.

A sounding part is modelled in a first step as a series of segments where each segment begins and ends with a strike or a lift and all strikes and all lifts give rise to a boundary between two segments. (In a second step all lifts following a strike are listed as a dimension of its own, LiftList in the segment, which starts with the actual strike and the segment limit, corresponding to the lift is removed by melting the segments together. The distance between a strike and the following lift is expressed in LiftList as an articulation ratio. In a third step performed in the constructor of the actual generator all segments of the part are divided into the moments k which exist in the K-set of the generator if k is comprised in the extent of time of the part. Then the suffix trees with the present parts are created. The reason for this third step is that all parts of the generator efficiently shall know what is going to happen in the part generated at all moments in K.

In order quickly to determine the tail similarity at different strings of comparison and at different cycles there is created at the initiation of the present invention for each type of calculation a suffix tree.

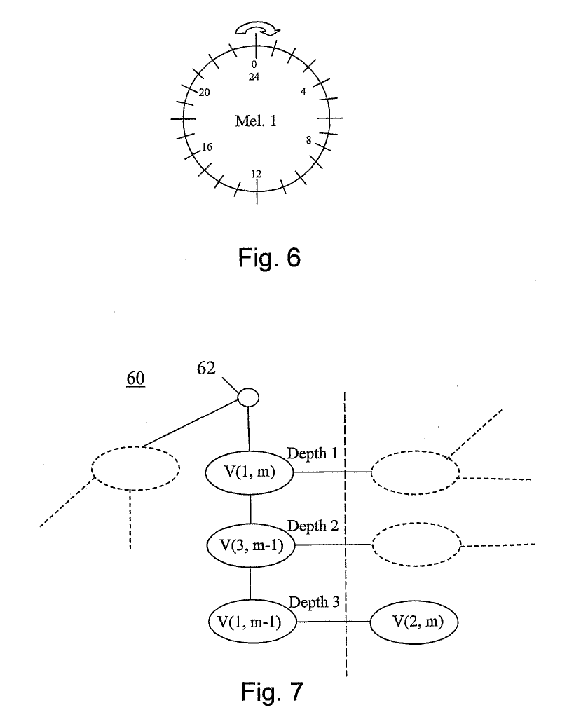

The suffix tree is described in FIG. 6. The figure is divided into two parts by a dashed line. The left part contains history, the right part contains future. The history side is the actual suffix, or rather prefix, and contains all sequences of the part of the dimension given by the comparison string from the root and downwards. The future side contains possible future scenarios for each suffix/prefix. These can consist of only one level, i.e. the dimension that the tree is intended to determine as sketched at the bottom right of the figure. But it may also as sketched by the dashed figures at the right top contain a number of sub trees. The different levels of these sub trees will then contain different dimensions and can be assumed to vary together with the dimension that the tree is intended to determine. In most cases the future trees will contain dimensions and values derived from the same segments as the dimensions of the nodes closest to the root on the history side. This can be illustrated by the following example:

When the melody generator is to determine a new pitch in the segment p the determination of MelRelPitch in p constitutes the real task. A search is made over all parts according to the principles of first come, first serve and the principle of choice. But there is interest not only in the distance between the new pitch and the pitch of the previous strike, but also in the consonance value of the new pitch. The patterns of consonance and dissonance of the input parts shall be preserved. When building the future branch not only MelRelPitch but also MelOnCC is taken into consideration and this implies, according to one embodiment of the invention, that the algorithm which chooses the alternative for MelRelPitch of the part makes the original value of the future branch dissolve up to at least the same consonance value according to the generated harmonic sequence. In such a way there is preserved a combination of gestural characteristics and treatment of dissonance. It would also be possible to involve MelPitchReg in order to additionally weight the alternatives of the parts with respect to the location of different patterns in the pitch register.

The basic algorithm in the generators for sounding parts can, according to one embodiment of the invention, be written in pseudo code as follows:

The variable gNow holds the current value for the “now” of the generator, usually the same as Ost in the segment, which is now being generated. The variables “all pNow” refer to the individual Now:s of the input data parts.

For each gNow and each generated segment:
1. Determine if a lift shall be made
   a. If yes,
      i. Determine what notes shall be released
      ii. Send data to Sequencer
2. Determine Strike, i.e. if a strike shall be made.
   a. If yes,
      i. Determine what notes shall be onset and how
      ii. Send data to sequencer
   b. If no, no action.
3. Determine RemStrikeDur (choice, first to come first to serve or egalitarian).
4. Determine al, the number of lifts between the previous strike and the following strike.
   a. If LiftCount>=al, no action
   b. Otherwise: determine point of time for the subsequent lift:
      i. Determine articulation ratio, ak, for the next lift (egalitarian interpolation).
      ii. Determine the time, t, for the subsequent lift by means of ak and RemStrikedur.
      iii. If (t<subsequent gNow),
         1. Determine the notes to be released at t.
         2. Send data to Sequencer.
         3. Increment LiftCount
      iv. Otherwise no action.
5. Increment gNow (and all pNow), increment to the next segment.

The algorithm complies with two important properties. Firstly there are achieved strikes without the determination of point of time for any of its lifts or point of time for the next strike. A note which, by a part is considered to be long may after the strike, if the state is changed be reinterpreted by another theme as a shorter note. Secondly it will be possible to interpolate over articulation.

Calculation of a point of time for a lift via RemStrikeDur and articulation ratio is typical for the present invention. A possible point of time for subsequent strike is determined before gNow has reached this point of time. This value exist only as an interim value which as a possibility can be changed many times before the next lift or strike takes place. At Strike/strike there is determined also the velocity of the onset notes.

According to one embodiment the sounding generators are also provided with “an assistant generator” TimbreShifter which handles timbres and volume. When a generator starts playing in a corner only the timbres of the corner theme are sounding. When the state moves to another corner, the timbre will smoothly be transformed to the timbres of the new corner theme which, in accordance to one embodiment of the invention, is achieved by performing changes of timbre by playing the same notes in e.g. several midi channels simultaneously and letting volume of one channel increase while the volume of the second channel is decreased so as to make the total volume appear unchanged according to prior art techniques. According to another embodiment of the invention changes of timbre are made in the frequency domain.

The bass part according to the present invention is unison, i.e. it never plays more than one note at a time. In the algorithms for the generation of the bass part the principle of interim values is driven far. The assumption for the bass part is that bass is played by moving from one chord note close to a down beat (se wordlist) to a chord note close to the next down beat via zero or several other chord notes, from one chord note to another via zero or several scale notes and from one scale note to another via zero or several non-scale notes. A new interim future is projected for each new gNow according to the following embodiment of an algorithm:

For each gNow and each generated segment:
1. Determine tpne, point of time for next down beat, by using CS and the configured bar length of the part.
2. Determine tpa, point of time for anne, an onset chord note close to tpne.
3. Determine tka, pitch for anne
4. Determine aa, the number of chord notes to be onset after gNow and before tpa.
   a. if aa>0
      i. Determine tpa, point of time for the next chord note
      ii. Determine tpa pitch for next chord note
   b. Otherwise,
      i. Set tpna:=tpa
      ii. Set tkna:=tka
5. Determine as, the number of scale notes to be played after gNow before tpna
   a. If as>0
      i. Determine tpns, point of time for next chord note
      ii. Determine tkns, pitch for next scale note
   b. Otherwise,
      i. Set tpns:=tpna
      ii. Set tkns:=tkna
6. Determine ai, number of non scale notes to be played after gNow, before tpns
   a. If ai>0
      1. Determine tpni, point of time for next non scale note
      ii. Determine tkni, pitch for next non scale note
   b. Otherwise,
      i. Set tpni:=tpns

The present invention is perhaps better understood in the case where every theme has the same ensemble. All generators fetch one part from each theme. Each generator is playing all the time and the themes morph into each other as the variables of state are changed. But it is also possible to use a set of themes with different ensembles. The orchestra will always consist of the union of the ensembles of all themes. A mechanism is required to set generators in a state of “tacet”, i.e. it has to be possible to switch off the generators. This is done by means of the threshold values tsCP1 and tsCP2 for CP1 and CP2 respectively. These can be configured on theme level or on a global level.

Consider the instance with two themes with different ensembles, T1 (CS, Mel, CP1, Ba) and T2 (CS, Mel, CP2, Ba). An orchestra will then be created consisting of CS, Mel, CP1, CP2 and Ba. The themes will be assigned one state variable each, S1 and S2 respectively. If the orchestra is initiated in the corner h1=(maxS1, minS2) T1 will be played by the ensemble of T1. If the state is moved towards h2=(minS1, maxS2) CP1 will stop playing when S1<tsCP1. CP2 will start playing when s2>tsCP2. The mechanism is complemented with musical conditions on theme level to determine when in the generated music the generator is to stop playing. These “end conditions” mainly deal with dissonance treatment.

By setting such thresholds higher than zero for all themes and having all state variables defined over R⁺ [symbol] {0} there is obtained an embodiment where states close to the origin (0, 0, . . . , 0) implies that the orchestra stops playing.

Thus a theme does not have to include parts for the full ensemble of the orchestra. One or several themes may contain material for only one single part or even for only certain aspects of one or several parts, for instance interval contents or dynamics. It is possible in the configuration information of the theme to specify the aspects of the theme to be exported, i.e. being considered by the generator in question. In the cases where an export part or an aspect of a part is dependent of other aspects of the same part or of other parts, the theme must contain these aspects or parts or refer to the corresponding information in other themes.

For example, If a theme is used only to affect the dynamics of a melody part volume information shall be placed for that melody part as the only musical information in the mid file (or corresponding file) for the theme. In the configuration information of the theme it will be specified that the theme of that part does not export notes but only dynamics. The theme however has to contain CS, either a CS of its own or refer to the CS of another theme, otherwise the repositioning procedure for the theme will be impossible to perform.

The above described method for handling metrical characteristics by using cycle signatures can be expanded so that themes of arbitrary metrical structure can be described and utilized. If the form of a theme is described by using a “form string” with capitals for the different sections, for instance AABAACC . . . , where all As are equally long, all Bs are equally long etc. and if the metrical characteristics in each section A, B, C, . . . can be described with cycle signatures as defined above it will be possible to associate different cycle signatures with different sections and thus the present invention can handle themes with arbitrary, e.g. non symmetrical, metrical structure. The nows of the input parts would then be supplied with an extra field indicating section. The time position field would indicate how far into the current section the now is. Similarity of time between t1 and t2 still exists according to equation 1 down to GCD (sc1, sc2), where sc1 and sc2 are the shortest cycles in the cycle signatures of the sections of t1 and t2, quite similar to the how it would be had the sections been different themes.

In one implementation the system generates midi material. Even if midi controlled instruments today can have a considerable richness of timbre and sampling technique provides certain possibilities it is still difficult to handle for instance human song within the framework of midi. It is however possible to extend the present invention to make it able to handle recorded fragments on sound files (.wav, .mp3 etc). It is possible to associate a musical analysis in midi format with the file in question and to give the present invention a possibility to analyse the contents in a way similar to the way it analyses other input data. With that information the sound file can be used as a part of the generated music and adhere to the restrictions, primarily regarding the treatment of dissonance/consonance and the harmonic sequence, implied by playing of the sound file.

The system is able to exploit the fact that notes in traditional music are set on at positions in time, which can be specified, as in traditional music notation, by means of the equivalents to multiples of relatively small integers, very often only of 2 (whole notes, half notes, quarter notes etc.) and of 3 (triplets). If music in input comprises small displacements with respect to the time positions corresponding to our simplest note values, the picture will become more complex. It is possible to note such displacements with traditional notes but usually not desirable. The sequencer program available on the market since long resolve this by letting the micro displaced time positions remain in the underlying information, while the music will be represented by notes which are quantified, i.e. the are displaced to the next higher note values configured by the user. In a similar way, the present invention, according to one embodiment, can handle micro displaced notes by using a user configured quantification so that the onset times are handled as if on their quantified positions and the displacement can be handled separately for example by interpolation.

The system is also capable to find good transitions between different CS even if these lack common scaleChords. In one embodiment this will be made possible by using a measure of the similarity between two scale chords A and B, based on the number of common pitches and the average distance between the pitches in the chord and scale respectively in A and B respectively expressed as half tone steps. If a part does not find the latest played scaleChord on the actual or a similar time position it can be allowed to put its weight on that of the scaleChords on a similar time position as the partNow that are most similar to the previous one. This similarity can, depending on configuration, be determined in the original key of the input part, within the key that gives the most similarity, or in the current key of the generated music. The user may configure the right of the themes to pull the generated harmonic sequence to the themes own harmonic sequence in this way.

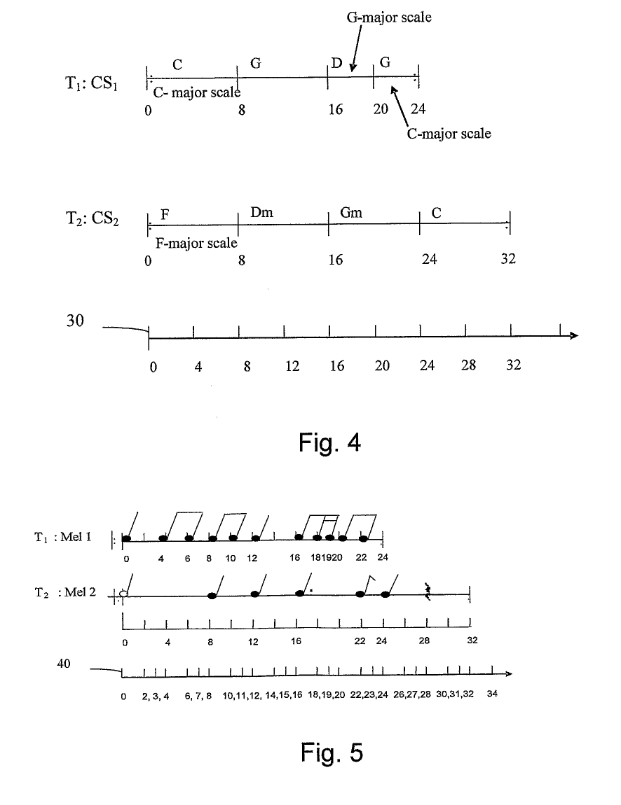

FIG. 4 schematically illustrates two scaleChord sequence input parts, CS₁ and CS₂ from imaginary exemplified themes T₁ and T₂ and the time axis for the generated scaleChord sequence, intended to be handled by the CS generator. In accordance with the discussion above CS₁ will, in a first step, contain four segments with the limits 0, 8, 16, 20, 24 (=0 (mod 24)). These will contain dimensions which, among other things, describe the current chord, (C, G, D and G major triad respectively) and current scale (G major scale in all segments except in (16, 20) which contains a D major scale. CS₁ is configured with a cycle signature {24, 8} for all calculations. CS₂ will in a corresponding way in step one contain four segments with the limits 0, 8, 16, 24, 32 (=0 (mod 32)). CS₂ is configured with a cycle signature {32, 16} for all calculations. The step cycle of the CS generator will with these two input data parts only become the greatest common divider of the shortest cycles {8, 16}=8. By using equation (3) the set B={0, 4} and starting points in the set K={0, 4}8={0, 4, 8, 12, 16, . . . } will be obtained for the CS generator. The segments in both CS₁ and CS₂ will then be divided in all the points of time defined by K. CS₁ and CS₂ will consist of six and eight segments respectively having a length of four. The critical points of time for the CS generator are marked on time axis 30 at the bottom of the figure.

In a corresponding way the melody input data parts to T₁: Mel₁ and T₂: Mel₂ according to FIG. 5 will be treated with the cycle signatures {24, 8, 4} and {32, 16} respectively. The Mel generator will be given the step cycle gcd (8, 4, 16) 4. 8 is the step cycle of the superior generator (CS). calculated in FIG. 4 and will, as described above be considered in the calculation of the step cycle of the subordinated generator. The set B {0, 2, 3} the FIG. 3 in B derives from 19(mod 4), the remaining onset times give 0 or 2, for example 4(mod 4)=0, 10(mod 4)=2. When forming the B of the Mel generator, the B of the superior generator (CS) shall be taken into account, but will in this case not add any further elements. The set K={0, 2, 3}₄={0, 2, 3, 4, 6, 7, 8, 10, 11, . . . }of the Mel generator is marked along the time axis 40 at the bottom of the figure.

FIG. 6 shows how the input theme T₁ is cyclical. This is valid also for T₂ above and most themes, which are used in the present invention. In one embodiment of the invention also non-cyclical themes can be used for introductions and terminations of the music generated.

In FIG. 7 there is shown the finding by a generator of a relevant value for calculation of the next generated date from a suffix tree 60 having a root 62 by comparison by means of tail similarity according to one embodiment of the present invention. The tree houses part of the information in some of the segments of an input data part. The following table shows the subsequent segments from the part.

Segment

| m − 1 | M | m + 1 |
|---|---|---|
| v(1, m − 1) | v(1, m) | v(1, m + 1) |
| v(2, m − 1) | v(2, m) | v(2, m + 1) |
| v(3, m − 1) | v(3, m) | v(3, m + 1) |

The table shows the segments m−1, m and m+1, each containing values v (a, b) for three different dimensions 1, 2 and 3. The unbroken nodes in the figure show how the value for dimension 2 in a segment i, v(2,i) depends of v(1, i), v(3, i−1) and v(1, i−1).

The comparison string in this case will be (1)(3, 1). The figure is divided by a vertical dotted line. On the left hand side there is history, on the right side is future. This means that values on the future side depend of values on the history side. The dotted nodes on the future side indicate that they can grow out to sub trees if several dimensions are introduced on the future side. This can be made to house information concerning the co-variation of these dimensions.

Preferably, the linking of the values can be made in the form of a suffix tree 60, but other previously known linkings could also possibly be used.

In the present example the generator finds a value V(2, m) at the level/depth 3, which implies sufficient tail similarity according to a predetermined criteria for depth to make it qualify as input data for the calculation of the next generated data. In the calculation consideration is also made with respect to the frequency by which the current value v(2, m) appears and the current weight of state for the input data part.

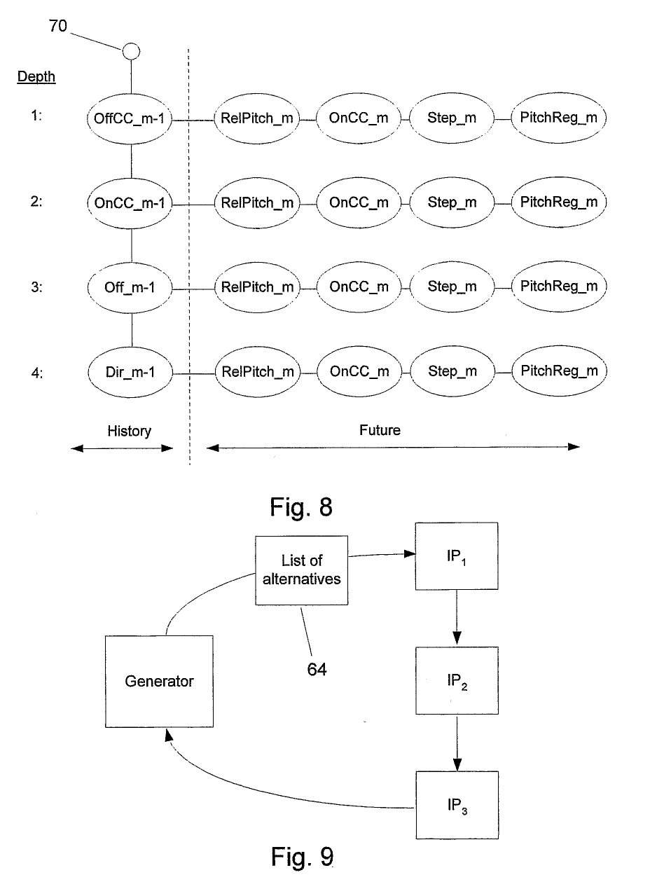

FIG. 8 schematically illustrates how a suffix tree is housing information from an input data part concerning the dependence of values of different dimensions in a segment from values of dimension in segment m−1 according to one embodiment of the present invention. The input data part is a melody input data part and may be one of several parts used as a melody generator for material to a melody generated. Each segment of the input data part has a set of dimensions each having a value, which describes the properties of the part in that segment in accordance with the following tables over some segments and their dimension values.

| Segment m − 2 | Segment m − 1 | Segment m |
|---|---|---|
| RelPitch_m − 2 | RelPitch_m − 1 | RelPitch_m |
| OffCC_m − 2 | OffCC_m − 1 | OffCC_m |
| OnCC-m − 2 | OnCC_m − 1 | OnCC_m |
| Dir_m − 2 | Dir_m − 1 | Dir_m |
| PitchReg_m − 2 | Pitchreg_m − 1 | PitchReg_m |
| Ost_m − 2 | Ost_m − 1 | Ost_m |
| Off_m − 2 | Off_m − 1 | Off_m |

The table does only contain three segments, where as input data part may contain considerably more. The tree in FIG. 8 can be used to choose input data for the calculation of pitch in a newly generated segment.

The tree in FIG. 8 has its root marked as 70 and has history on the left side of the dotted line and future on the right side of the line.

The comparison string for the current calculation is ( )(OffCC, OnCC, Off, Dir). The empty tuple at the beginning of the string shall be interpreted so that no values in m are used to determine the pitch in m. Dimension values in accordance with the comparison string are found to the left of the dotted line as the so called history string.

For each node in the history string there is built a “future branch” which houses information concerning the dependence of a new pitch of the history string of the respective depth. These future branches are found to the right of the dotted line in the figure. The future branches will, if several different values appear in the inner nodes, form a sub tree in accordance with what is described in the explanation of FIG. 7.

The dimensions of the comparison string are:
OffCC the consonance value of the pitch in the subsequent segment
OnCC the consonance value of the pitch in this segment,
Off final time for this segment (=equal to the staring time for the next),
Dir direction of the melodic movement, which gave the pitch in this segment.

Dimensions of the future branches are:
RelPitch the pitch of the segment in relation to the pitch in the previous strike, expressed as half notes up or down,
OnCC the consonance value of the pitch in this segment. OnCC is included to make it possible to dissolve the pitch chosen to at least this value with respect to the generated harmonic sequence.
PitchReg expresses the register where the new pitch will end up. It can be used to weight different alternatives in a reverse proportion to the distance to the register where they end up at generation. See further register dimensions in the wordlist.

The tree is built to make the dimension values for the segments of all input data parts into history strings and future branches as described in connection with FIG. 8.

A melody generator generates unison melodies on basis of its input data parts. If we assume that a melody generator according to the algorithm for sounding generators, which has been described above, has decided strike a new note. The comparison string and the previously decided minimal depth defines that input for the calculation of a new pitch in the next generated segment g can picked from the future branch at this depth if tail similarity according to the comparison string is present. If the previously decided depth is four and values of the latest generator segment g−1 corresponds the values in m−1, namely

OffCC_{—}g−1=OffCC_{—}m−1 (a)

OnCC_{—}g−1=OffCC_{—}m−1 (b)

Off_{—}g−1=Off_{—}m−1 (c)

Dir_{—}g−1=Dir_{—}m−1 (d),

then input data for the calculation can be written in the list for alternatives being sent around by the generator (see below) in accordance with the future branch at the bottom right in FIG. 8. If the minimal depth is three and the equalities (a)-(c) are valid data can be chosen from the future branch at the bottom but one right etc. The point of time Off is compared to the pNow of current input data part and similarity (c) is valid if equation (1) is valid using the value for the cycle currently used in the calculation.

In the model of one embodiment, there exists the distinction step/leap concerning the interval of the melody. Patterns of steps/leaps in the melody data parts shall have a bearing on the melody generated. If there is a conflict between OnCC and step/leap, for instance if a current consonance value cannot be reached without leaps, then an algorithm has to dissolve these conflicts. According to one embodiment the user may in this case configure the system in accordance with his preferences.

The order of which the different dimensions are introduced in the future branches is irrelevant except that PitchReg, which has a continuous set of values, has to be located in the leaves.

The frequencies of appearance are also written into the leaves of the future branches. When weighting for different alternatives the values are collected and the values for RelPitch are written into the list together with their weights, which in this case is the product of frequency of appearance and weight of state, possibly adjusted with respect to register as has been indicated above.

In FIG. 9 there is illustrated how a generator is sending around a list for alternatives to its input data parts IP₁, IP₂, IP₃ to collect input data for the next calculation of musical data in accordance with the procedure described in FIG. 8. The input data parts write their input data in the list if their weight is bigger than zero and the tail similarity demanded is at hand according to the above. What will happen if this demanded similarity is not present is different in different in different calculations. If for the current calculation it is important that each input data part shall contribute with data the list will be sent once to each input data part and the requirement are reduced “locally” for each input data part to a certain level and data are picked from the input data part if the requirements are complied with. This strategy is called egalitarian.

If however for the current calculation alternatives are preferred showing as big a tail similarity as possible, the list is sent around to all input data parts turn by turn and the requirements are lowered for each turn down to a certain level or until one or several input data parts have written into the list. This strategy is called “first come, first served”.

Independent of the strategy chosen for a certain decision, the requirement for tail similarity can be lowered in two different ways. Almost all calculations for tail similarity take into consideration the point of time where in the current input data part the values compared exist and the data thereby chosen. Either the requirement for tail similarity shown is decreased by lowering the depth of tail similarity or the requirement is lowered by looking for time similarity at shorter cycles, i.e. to look for tail similarity at points of time which are increasingly less equal to the pNow of the current input data part.

For certain calculations also certain other demands have to be fulfilled to enable the input data part to write into the list. For instance there may be a requirement for certain equalities between the cycle signatures of the current input data part and the input data part having the highest dynamic weight.

Some values are global to a sounding part as a whole, for example highest and lowest sounding notes and highest and lowest sounding notes of specific scale-functions. The sounding generators entertain those values for example by linear interpolation over the corresponding values of input parts and their state variables. The highest and lowest of sounding notes constitute more or less hard boundaries for the pitches in the generated music. Due to for example treatment of dissonance these boundaries cannot always be strictly followed, but if such a value in a generator is found to be out of bounds a strike can be forced at that point in time if enough input parts has a strike at their current pNows (mod their shortest cycle), so as to adjust that parameter to an inbound value. A value for “numberOfSoundingNotes” can in one embodiment of this invention be updated at the beginning of every segment and a strike can in a similar fashion be enforced if that value is considerably out of bounds.

To avoid clashes of different rhythms within the same beat, for example the consecutive onset of the second sixteenth-note and the third eighth-note triplet within the same quarter-note, something that could happen in the generated music even if that rhythm never occurred in input, in one embodiment of the invention a “beat-position filter” is used. This means that an input part endorses a strike only if it has had a strike at the beat-position of the previously generated strike (on some cycle), as perceived from the parts own pNow:s point of view. Thus a value of the last generated strikes beat-position is entertained in the input part, given by t (mod beat-length) where beat-length is a configurable value. This filter can be suspended by the individual input part when its pNow reaches a new beat.

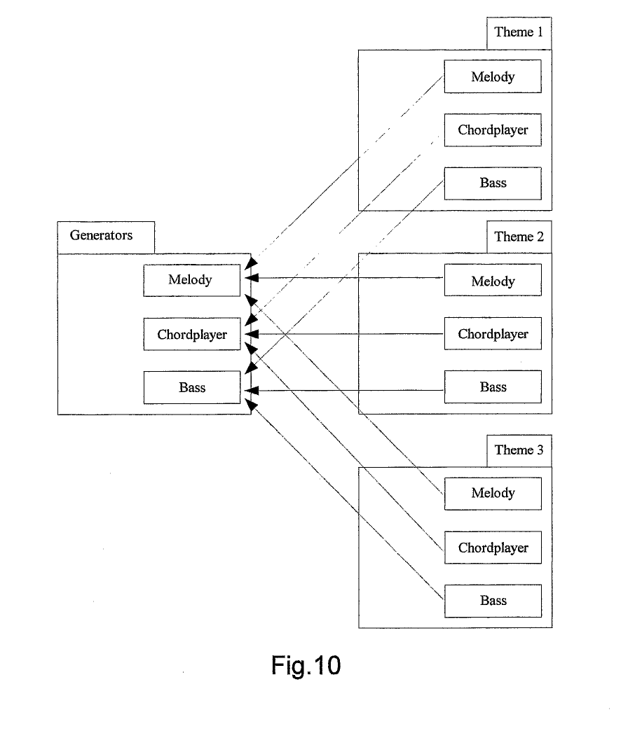

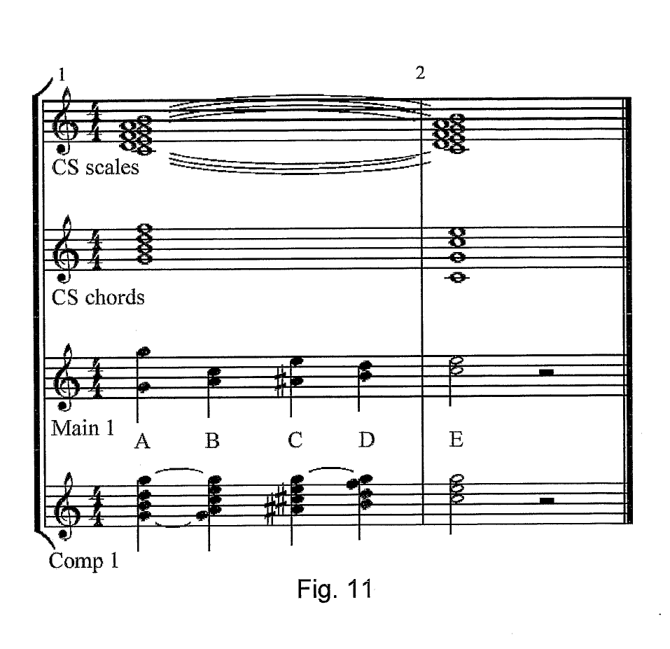

FIG. 10 illustrates how the respective generators at the system initialisation, the system fetch parts from their respective type of part from the input data themes 1, 2 and 3.

Yet another aspect of the system as described herein is the use of a ChordPlayer (CP), a chord-playing part type. CP is a part type that can play more then one sounding note at a time. CP is basically an extension of Mel. The model is focused on treatment of dissonance and gestural characteristics. Thus consonance categories play an important role. In Mel as described earlier, all chord notes are treated the same according to the notion that if a chord note can be played at a specific musical moment, another chord note will work well too. In CP it is more elaborate. In order to be able to morph between different multipart harmony input parts it is described how notes of different function and meaning, as related to the harmonic sequence, behave and evolve. For example, abstractions to describe how notes are distributed over the registers (“over the keyboard”) so that different input parts can influence the generated part even if they have no common scaleChords are needed. Furthermore, it is advantageous to catch common characteristics in how pitch-class sets of simultaneously sounding or struck notes evolve over the harmonic sequence across input parts with different scaleChords. To that it is possible to use a scale function (ScFunc).

A scale function is the role played by a specific pitch-class in the presence of a specific ScaleChord, i.e. the function of that pitch-class in that scaleChord. We create a mapping

### ScaleChord×PitchClass→ScFunc

defined over all scaleChords and all pitch-classes. The abstraction of scale functions can be understood as a way of seeing scales and chords as derived from the natural overtone spectrum. If the frequency of a sounding tone is f, the overtones have frequencies 2 f, 3 f, 4 f, 5 f, . . . . The lower overtones correspond well to scale steps used in music. Expressed as musical intervals and without the f we get: 1 (root or prime), 2 (octave), 3 (octave plus pure fifth), 4 (double octave), 5 (double octave plus major third), 6 (double octave plus pure fifth), 7 (double octave plus minor seventh), 8 (triple octave), 9 (triple octave plus major second) etc. The first sixteen overtones can be seen as generating, among other material, the scaleChord (major triad, jonic scale) as suggested by table 1. The intervals from the prime are transposed to the octave starting at the prime.

| | | Note name | Interval |
|---|---|---|---|
| Overtone | Scale step | in C | from prime |
| 1 | PRIME | C | 0 |
| 2 | PRIME | C | 0 |
| 3 | FIFTH | G | 7 |
| 4 | PRIME | C | 0 |
| 5 | THIRD | E | 4 |
| 6 | FIFTH | G | 7 |
| 7 | MINOR SEVENTH | “Bb” | 10 |
| 8 | PRIME | C | 0 |
| 9 | SECOND | “D” | 2 |
| 10 | THIRD | E | 4 |
| 11 | FOURTH | “F/F#” | 5/6 |
| 12 | FIFTH | G | 7 |
| 13 | SIXTH | “A” | 9 |
| 14 | MINOR SEVENTH | “Bb” | 10 |
| 15 | MAJOR SEVENTH | “H” | 11 |
| 16 | PRIME | C | 0 |

First the scale steps PRIME, FIFTH and THIRD are formed. For the scale steps formed by higher overtones—MINOR SEVENTH, SECOND, FOURTH, SIXTH and MAJOR SEVENTH—the differences in pitch between the overtones and the scale steps normally used in music becomes more and more troublesome witch is indicated by the quotation marks around the note names.

A seven note scale is created by transposing the pitches to the same octave and get PRIME, SECOND, THIRD, FOURTH, FIFTH, SEVENTH (OCTAVE).

A scale function s for a pitch class with the interval from the root r has two components, s.value, and s.offset. Value states the main function of s. Offset is r−n, where n is the interval of the pitch-class with the scale function (s.value, 0). Scale functions with offset=0 are called main functions.

The principle of the mapping

scaleChord×pitch-class→ScFunc,
from an arbitrary scaleChord and any pitch-class to scale functions used herein is illustrated by the following:
1. Decide the number of main functions.
2. Assign all main functions. (section three and following) Main functions are assigned to pitch-classes firstly to consonance categories of higher value, for example firstly to chord notes, secondly to scale notes and thirdly to non scale notes and all main functions are assigned to intervals as close as possible to what is suggested by the overtone spectrum according to the previous discussion:
3. Assign “prime”, (prime, 0) as close to the root as possible
4. Assign “fifth” (fifth, 0) close to 7, splits the octave,
5. Assign “Third” (third, 0) close to 4, between prime and fifth
6. Assign “seventh” (seventh, 0) close to 10, between fifth and octave
7. Assign more main functions to pitch-classes between already assigned main functions until the desired number of main functions is reached. After the four already assigned it is possible to assign “second” between prime and third, “fourth” between third and fifth, “sixth” between fifth and seventh and so on.

After the main functions have been assigned the rest of the pitch-classes get their scale functions. The details are governed by the following table, called Preferences.

{

| | |
|---|---|
| {0, 1}, | // ”prime” |
| {7, 6, 8}, | // ”fifth” |
| {4, 3, 5, 2}, | // ”third” |
| {10, 11, 9}, | // ”seventh” |
| {2, 1, 3}, | // ”second” |
| {5, 6}, | // ”fourth” |
| {9, 8} | // ”sixth” |

};

The mapping of scale functions in this case uses seven main functions: prime, second, third, fourth, fifth, sixth and seventh. Preferences state most wanted interval, in semi-tones, for each main function. Most wanted interval for fifth is 7 semi-tones, thereafter 6, thereafter 8. Most wanted interval for seventh is 10, thereafter 11 and 9, etc. This means that if the chord of a scaleChord contains a pure fifth (7 semi-tones) and a diminished fifth (6 semi-tones) the pure fifth will get scale function (fifth, 0) and the diminished (fifth −1)

The whole assignment of scale-functions in the present implementation goes like follows:

First is assigned all main functions (offset=0),

First prime is assigned:

If the interval from the root 0 semi-tones (pure prime) is in the chord of the scaleChord, it gets the scale-function (prime, 0).

Else, if the interval 1 is in the chord, it is assigned the scale-function (prime, 0).

Else, if the interval 0 is in the scale of the ScaleChord, it gets (prime, 0).

Else, if the interval 1 is in the scale, it gets (prime, 0).

Else the interval 0 gets (prime, 0).

Thereafter fifth is assigned:

If the interval 7 semi-tones (pure fifth) is in the chord of the scaleChord it is assigned the scale-function (fifth, 0)

Else, if the interval 6 (diminished fifth) is in the chord, it gets (fifth, 0).

Else, if the interval 8 is in the chord it gets (fifth, 0).

Else, if the interval 7 is in the scale of the ScaleChord, it gets (fifth, 0).

Else, if the interval 6 is in the scale, it gets (fifth, 0).

Else, if the interval 8 is in the scale it gets (fifth, 0).

Else, the pitch-class at interval 7 is assigned (fifth, 0).

After that is assigned the main functions of third, seventh, second, fourth and sixth in the same way to the intervals stated by Preferences. When the main scale-functions have been assigned to their pitch-classes the rest of the pitch-classes are assigned scale-functions with offset ≠0. This assignment is done pitch-class by pitch-class starting with the intervals 0, 1, 2, . . . semi-tones from the root of the scaleChord. The assignment is only performed if the pitch-class has not yet received a scale-function. Let r be the interval between the root of the scaleChord and the pitch-class p that is to be assigned its scale-function. Preferences is read column by column, top down, from left to right until r is found. The value of p:s scale-function will be m, where m is the main function stated at the row in Preferences where r is found; offset of the scale-function of p will be r−n, where n is the interval between the root of the scaleChord and the pitch-class with the scale-function (m, 0).

Seven-tone scales dominate in the theory of western music, but with the help of scale-functions we can easily model scales with more or fewer steps. The ScaleChord

### {C, {C, D#, F#, A}, {C, D, D#, F, F#, G#, A, H}},

with the traditional notation of pitch-classes (C=0, C#=1, etc.) written as
{0, {0, 3, 6, 9}, {0, 2, 3, 5, 6, 8, 9, 11}},
maps with the described algorithm and with the use of Preferences, the pitch-classes on scale-functions as follows:

| Pitch-class | | Consonance | |
|---|---|---|---|
| number | Note name | Categories | ScFunc |
| 0 | C | T, C, S | (PRIME, 0) |
| 1 | C# | N | (PRIME, 1) |
| 2 | D | S | (SECOND, 0) |
| 3 | D# | T, C, S | (THIRD, 0) |
| 4 | E | N | (THIRD, 1) |
| 5 | F | S | (FOURTH, 0) |
| 6 | F# | T, C, S | (FIFTH, 0) |
| 7 | G | N | (FIFTH, 1) |
| 8 | G# | S | (SIXTH, 0) |
| 9 | A | C, S | (SEVENTH, 0) |
| 10 | Bb | N | (SEVENTH, 1) |
| 11 | H | S | (SEVENTH, 2) |

The notation of consonance values are T for in_triad; C for in_chord, S for in_scale and N for non_scale.

The scale of the scaleChord gets the scale-functions:

### (PRIM, 0), (SECOND, 0), (THIRD, 0), (FOURTH, 0), (FIFTH, 0), (SIXTH, 0), (SEVENTH, 0), (SEVEN, 2).

The chord becomes:

### (PRIME, 0), (THIRD, 0), (FIFTH, 0), (SEVENTH, 0)

All common triads, be they major or minor, augmented or diminished all look the same as scale-functions((PRIME, 0), (THIRD, 0), (FIFTH, 0)), as do all sevenths chords. Thus, in music with traditional harmonic structure, this abstraction can be used across different scaleChords so that CP input parts can influence the generated part even if they do not share its scaleChords. It is possible to keep records on the register values of individual scale-functions in the played chords, or the highest and lowest occurrences of scale-functions in a part as a whole and use these values to govern how the CP generator distributes notes of different scale-functions over the registers of the keyboard by for example mapping theses boundary values linearly as the dynamic weights of the themes vary over time and scale down probabilities for notes out of bounds.

Descriptions of how sounding and struck pitch-class sets evolve over the harmonic structure can form a basis for an automated understanding of multi-part harmony. A number of representations can be used for these sets, but scale-functions will do fine for this purpose also.

There are three major kinds of scale-function sets in play in the model of the CP. In each segment X of a CP part there are
1. SonSet, the set of all scale-functions sounding X.ost,
2. StruckSet, the set of scale-functions set on at X.ost,
3. PrStrSonSet, the set of scale-functions sounding at the last strike before X as interpreted by the scaleChord in X.

PrStrSonSet and SonSet describes how the set of sounding notes evolve over the harmonic structure of CS. StruckSet shows which scale functions that can be onset together. A set of these three types of sets can monitor the working of one part or the working of many parts together.

In order to give a composer the possibility to specify his or hers intentions beyond the regular input parts, i.e. the sounding input parts at they sound when the theme has converged in its own key at a state corner, it is possible to supply the score of a theme with complementary parts or comp-parts. One or more comp-parts can be linked to a regular (main) input part to in order to describe additional musical material. Notes in a comp-part is analyzed as being a part of its main part, with a few exceptions. The cardinality of the segment, the number of sounding notes, is given by main only. The rate of a scale-function s in segment X is the ratio

(the number of sounding notes of s in X)/(X.cardinality)

The rates of the scale-functions as well as the register values between highest and lowest can also be given by main. Scale-functions in comp but not in main are given values from notes in main similar to them in terms of consonance and scale-function.

The three types of sets are illustrated in FIG. 11.

A CP part 1 is defined by Main 1 and Comp 1 and consists of the segments A, . . . , E. If both Main 1 and Comp 1 are considered when constructing SonSet, StruckSet and PrStrSonSet for each segment, we will get the following table: (The pitch-class sets are included for readability)

| | Scale-function set | Pitch-class set |
|---|---|---|
| A.SonSet | {(PRIME, 0), (THIRD, 0), (FIFTH, 0)} | {G, H, D} |
| A.StruckSet | {(PRIME, 0), (THIRD, 0), (FIFTH, 0)} | {G, H, D} |
| B.SonSet | {(PRIME, 0), (SECOND, 0), (FOURTH, 0), (SIXTH, 0)} | {G, A, C, E} |
| B.StruckSet | {(A, SECOND, 0), (A, FOURTH, 0), (E, SIXTH, 0)} | {A, C, E} |
| B.PrStrSonSet | {(G, PRIME, 0), (H, THIRD, 0), (FIFTH, 0)} | {G, H, D} |
| C.SonSet | {(PRIME, 0), (THIRD, −1), (FIFTH, −1), (SIXTH, 0)} | {G, A#, C#, E} |
| C.StruckSet | {(PRIME, 0), (THIRD, −1), (FIFTH, −1), (SIXTH, 0)} | {G, A#, C#, E} |
| C.PrStrSonSet | {(PRIME, 0), (SECOND, 0), (FOURTH, 0), (SIXTH, 0)} | {G, A, C, E} |
| D.SonSet | {(PRIME, 0), (THIRD, 0), (FIFTH, 0), (SEVENTH, 0)} | {G, H, D, F} |
| D.StruckSet | {(THIRD, 0), (FIFTH, 0), (SEVENTH, 0)} | {H, D, F} |
| D.PrStrSonSet | {(PRIME, 0), (THIRD, −1), (FIFTH, −1), (SIXTH, 0)} | {G, A#, C#, E} |
| E.SonSet | {(PRIME, 0), (THIRD, 0), (FIFTH, 0)} | {C, E, G} |
| E.StruckSet | {(PRIME, 0), (THIRD, 0), (FIFTH, 0)} | {C, E, G} |
| E.PrStrSonSet | {(SECOND, 0), (FOURTH, 0), (FIFTH, 0), (SEVENTH, 0)} | {D, F, G, H} |

Note that PrStrSonSet for B, C and D is the same as SonSet of the previous segment since they all play at the same G7-mixolydian scaleChord. The value of E.PrStrSonSet is the scale-function set of the sounding pitch-classes of segment D as interpreted with the C-major tonic of segment E.

The three types of sets can be used in the generation of a CP part in the following way. For every new generated segment after the first its PrStrSonSet is updated from already generated data and the scaleChord of the segment. A function F (“prStr”) in each input part

F: X.PrStrSonSet→{s | s is a possible scale-function in X.SonSet}
can then by means of information about each, of its segments PrStrSonSet and SonSet answer “given that segment X has this PrStrSonSet, which scale-functions can then be found in X.SonSet?”.

An other function G (“InScaleChord”) in each input part

G: ScaleChord→{s | s is a scale-function possible to play with the present scaleChord},
can answer “given scaleChord Y, which scaleChords can be played with Y”.

A third function H (“Rate”) in every input part

H:{M| M ⊂ X.SonSet}×t→{(s, rate) | s ε X.SonSet, rate ε R}
answer the question “given M ⊂ X.SonSet at time t (or a similar point in time according to equation 1), what will X. SonSet look like and what will be the rate of its scale-functions?”.

A fourth function I (“Struck”) in every input part

### I: {N| N ⊂ X.StruckSet}→{X.StruckSet}

answers “given N ⊂ X.StruckSet, which scale-function can be onset at the beginning of X?”.

For every note selected to sound in segment X, i.e. every new note added to X.SonSet function H must again deduce possible members of X.SonSet and their rate; for every new note chosen to be set on at X.ost, i.e. every new note added to X.StruckSet, function I must again deduce possible members of X.StruckSet.

A fifth function J (“Voicing”) in every input part returns for every possible candidate pitch p an eligibility weight w stating how well p fits into the context of the part presently being generated.

J: Generated part×Input part×F×G×H×I×{pitch p}×time→R

The function J uses the functions F, G, H and I as well as information on voice-leading and treatment of dissonance derived from the input part, in particular how notes in one segment grows out of previous segments. In part 1 score 1 discussed earlier the note C2 in segment E can be seen as coming from a stepwise motion one semitone up from H1 in segment D and D2 in segment D from a stepwise motion one semitone up from C#2 in segment C.

Function J can also preserve characteristics of the treatment of dissonance by considering consonance categories for the involved notes for such motions, as well as for moves by leap.

Furthermore function J can consider the register values of the involved notes derived either from their placement within the highest and lowest note of the part as a whole or of the sounding notes of the segment. J can also consider similarities in scale-functions between possible candidate pitches and to whether or not notes are bound into the segment

The generation of multi-part harmony must resolve conflicts between for example voice-leading and cardinality of simultaneously sounding scale-functions, or the avoidance of parallel fifths and octaves.

All the here mentioned aspects of similarity between input data and patterns occurring in the generated parts can be measured in such a way that different aspects of a notes eligibility can be considered simultaneously in the weight returned by function J and the most eligible notes be chosen.

Given this model of scaleChords, scale-functions and scale-function sets the main parts of the CP algorithm for choosing notes to a segment can be stated:
1. Deduce the segments cardinality,
2. Deduce possible pitch-classes given on the one hand what has been played before, on the other the current scaleChord
3. Chose notes considering voice-leading, treatment of dissonance, register placement etc.

A more detailed description of the selection of sounding notes for a segment X of a generated CP-part can be written:
1. Decide n, the cardinality of X, for example by interpolating linearly over the input parts and their dynamic weights,
2. Update the scale-functions for all 12 pitch-classes given the current scaleChord in
3. Update X.PrStrSonSet from earlier data
4. Derive M={possible members in X.SonSet} by means of functions F and G given X.PrStrSonSet and current ScaleChord,
5. X.SonSet :=ø,
6. X.StruckSet :=ø,
7. Derive rate for all possible scale-functions in X by means of function H given X.SonSet and the “nows” of the input parts,
8. Derive N={possible members in X.StruckSet} by means of function I given X.StruckSet
9. Derive the “hunger” of all scale-functions given their rate, current cardinality and n,
10. Derive eligibility weights for all possible candidate pitches by means of function J,
11. Chose an eligible note e and, if e is presently sounding, decide whether or not to restrike it.
12. Add the scale-function of e to X.SonSet and, if it is to be struck, to X.StruckSet
13. Repeat 7-12 until number of chosen notes=n
14. Send data.

The “hunger” mentioned in 9. is a function that for every pitch-class returns a value for the urgency by which the pitch-class needs more notes in the segment to reach its rate.

If rate >0, then hunger >0. In order to be able to balance between voice-leading and other considerations the hunger of a pitch-class will be greater than 0 even if it has exceeded its rate.

In some cases input parts cannot recognize a set S sets given as argument to the functions F, H and I. Then it is possible to use a maximal subset of S in order to give the part a chance to voice its opinion.

It is possible to use the described logic of SonSet, StruckSet and PrStrSonSet to represent the union of notes sounding and onset by more than one part in order to analyze or control the total sum of the music played by those parts. Then it is possible to adjust the measures of similarity described above so that patterns of voice-leading and treatment of dissonance are given more importance in parts with more pronounced melodic characteristics and more consideration to scale-function rates in the unions of all sounding notes are given in parts of more accompaniment nature. Such a differentiation is also possible between higher and lower notes in the same part.

Further, the system can perform harmonic modulations in a controlled and user configurable way. The key of the music is identified by means of the pitch-class sets of the scales of the scaleChords. Given a scaleChord sc at a time position t the invention can identify scaleChords transposed to other keys that constitute modulations of sc. The transpositions of the scales of the scaleChords are central here, not the chords. If the similarities of time positions according to equation (1) are considered, controlled modulations can be performed without corrupting the metric structure of the music. Table x gives an example. A short cadenza piece consists of four equally long bars. Metrically the piece is considered to consist of two two-bar cycles. There are four time positions of interest and given the two cycles and equation (1) we get that 0 is similar to 2 and 1 is similar to 3.

Time positions

| | | 0 | 1 | 2 | 3 |
|---|---|---|---|---|---|
| Short cadenza piece | Chords | C | C | F | G |

| | | |
|---|---|---|
| in C major: | Scale | C-major |

Time positions

| | | 0 | 1 | 2 | 3 |
|---|---|---|---|---|---|
| Same piece transposed to | Chords | G | G | C | D |

| | | |
|---|---|---|
| G major: | Scale | G-major |

Time positions

| | | 0 | 1 | 2 | 3 |
|---|---|---|---|---|---|
| Same piece transposed to | Chords | F | F | Bb | C |

| | | |
|---|---|---|
| F major: | Scale | F-major |

| | | Time positions | | | |
|---|---|---|---|---|---|
| | | 0 | 1 | 2 | 3 |
| Generated modulation (a): | Chords | C | G | C | D |
| | Scales | C-major | G-major | | |
| | | Time positions | | | |
| | | 0 | 3 | 0 | 1 |
| Generated modulation (b): | Chords | C | D | G | G |

| | | |
|---|---|---|
| Scales | C-major | G-major |

Time positions

| | | 0 | 1 | 0 | 1 |
|---|---|---|---|---|---|
| Generated modulation (c): | Chords | C | C | F | F |

| | | |
|---|---|---|
| Scales | C-major | F-major |

Time positions

| | | 0 | 1 | 2 | 3 |
|---|---|---|---|---|---|
| Generated modulation (d): | Chords | C | C | Bb | C |

| | | |
|---|---|---|
| Scales | C-major | F-major |

The generated modulation (a) takes place at time position 1. The chosen G/G-major scaleChord that replaces the C/C-major constitutes a modulation from C-major to G-major. The generated modulation (b) also takes place at time position 1. The chosen D/G-major also constitutes a modulation from C to G. In this case the chosen scaleChord also implies a metric shift of one cycle, since the original time position of the D/G-major scaleChord is 3. Generated modulations (c) and (d) move in the opposite direction, from C to F, at position 2. In all four examples there are two scaleChords to choose from at the modulations. In order to choose the most suitable scaleChord a number of considerations can be made depending on the implementation or on configuration. For example it is possible to consider the likeness of the two adjacent scaleChords (in (d) C/C-major and Bb/F-major), or the likeness of scaleChord of the original sequence of the theme and the scaleChord that replaces it (in (d) the F/C-major to the Bb/F-major).

The intervals in which the modulations occur can also be configured. In all of the above examples modulations are done by one pure fifth up or down. Allowed modulations could be in any interval (semi-tone, whole-tone, minor or major third, fourth/fifth or tritonus) and/or expressed as any number of consecutive leaps of that interval up or down, e.g. one or two fifths up or down, one or two semi-tones up or down etc. These characteristics of how modulations can occur can also be dynamic so that a theme strives for one type of modulations when its state variable is low, and for another kind of modulations when the state variable is high.

It is also possible to let different state variables affect different aspects of the behavior of the same theme.

1. A method of generating music in real time derived from at least two pre-determined musical themes comprising the steps of:
generating a first segment of music, the first segment being derived from one or more of the musical themes,
calculating one or more parameters corresponding to at least one characteristic representing the context of the first segment,
determining the musical content of a second segment by comparing at least one of the parameters to the musical context of one or more of the musical themes, and
generating the second segment based on the comparison between the context of the first segment and the context of one or more musical themes.

2. A method according to claim 1, wherein each segment only comprises at most one point in time where notes are set on.

3. A method according to claim 1, wherein the second segment is subsequent or contemporaneous to the first segment.

4. A method according to claim 1, further comprising the step of generating a continuous flow of segments by continuously generating new segments.

5. A method according to claim 1, wherein, segments representing higher abstraction levels are generated before contemporaneous segments representing sounding notes.

6. A method according to claim 1, wherein the context parameter is a parameter representing a harmonic analysis or a metric analysis.

7. A method according to claim 1, wherein data representing the state of an external process is used when selecting which musical themes to derive a segment from.

8. A computer software program product that, when executed on a computer, performs the steps in accordance with the method of claim 1.

9. A system for generating music data comprising:
a unit for generating a first segment of music, the first segment being derived from one or more of the musical themes,
a calculation unit for calculating one or more parameters corresponding to at least one characteristic representing the context of the first segment,
a unit for determining the musical content of a second segment by comparing at least one of the parameters to the musical context of one or more of the musical themes, and
a unit for generating the second segment based on the comparison between the context of the first segment and the context of one or more musical themes.

10. A system according to claim 9, further comprising a memory for storing the musical themes.

11. A system according to claim 9, wherein a currently generated segment is subsequent or contemporaneous to prior segment(s).

12. A system according to claim 9, wherein, segments representing higher abstraction levels are generated before contemporaneous segments representing sounding notes.

13. A system according to claim 9, wherein the context parameter is a parameter representing a harmonic analysis or a metric analysis.

14. A system according to claim 9, further comprising a unit for receiving data representing the state of an external process.

15. A method according to claim 2, wherein the second segment is subsequent or contemporaneous to the first segment.

16. A system according to claim 9, wherein a currently generated segment is subsequent or contemporaneous to prior segment(s).

17. A computer readable medium including program segments for, when executed on a computer, causing the computer to implement the method of claim 1.
